(19) United States
(12) Patent Application Publication
(10) Pub. No.: US 2019/0193467 A1
(43) Pub. Date: Jun. 27, 2019

(54) PNEUMATIC TIRE

(71) Applicant: TOYO TIRE & RUBBER CO., LTD., Itami-shi (JP)

(72) Inventor: Kazuo Shimomura, Itami-shi (JP)

(73) Assignee: TOYO TIRE & RUBBER CO., LTD., Itami-shi (JP)

(21) Appl. No.: 16/216,271

(22) Filed: Dec. 11, 2018

(30) Foreign Application Priority Data
Dec. 27, 2017 (JP) 2017-250788

(51) Int. Cl. B60C 9/18; B60C 15/06; B60C 17/00

(52) U.S. Cl. CPC B60C 9/1807; B60C 15/0628; B60C 17/0036; B60C 2009/2019; B60C 2009/1828; B60C 2009/1842; B60C 2015/0696

(57) ABSTRACT

A tire includes: a tread portion including a tread surface; a pair of sidewall portions that extend inward in a tire radial direction from both sides of the tread portion in a tire width direction; and a pair of bead portions each of which includes a bead core that is elongated continuously to an inside of the sidewall portion in the tire radial direction and extends continuously in an annular shape in a tire circumferential direction, and a bead filler disposed adjacent to the bead core and outside the bead core in the tire radial direction. A density of the reinforcing cords changes in a range from 20% inclusive to 60% inclusive of a tire sectional height from a tire inner end in the tire radial direction, and such that an outside of an area, in which the density changes, has a low density of the reinforcing cords.

### CROSS-REFERENCE TO RELATED APPLICATIONS

This application claims priority of Japanese Patent Application No. 2017-250788 filed on Dec. 27 2017, the content of which is incorporated herein by reference.

### BACKGROUND OF THE INVENTION

### Technical Field

The present invention relates to a pneumatic tire.

### Related Art

As a tire for an automobile or the like, a pneumatic tire capable of achieving high steering stability has been demanded. Particularly, in areas where high-speed traveling is permitted, such as European countries, a high-gravity (G) load is applied to the pneumatic tire during high speed traveling. Accordingly, a design capable of securing high steering stability even under a high-G load has been demanded.

The pneumatic tire preferably has high rigidity to improve steering stability. For example, JP 2011-93395A, JP 2003-182318 A, and JP 2008-222072 A each disclose a tire which includes a reinforcing cord embedded in each of a sidewall portion and a bead portion to improve rigidity of the sidewall portion and the bead portion.

### SUMMARY

The reinforcing cord which increases rigidity is effective in improvement of steering stability. However, the reinforcing cord produces uneven rigidity distribution in the sidewall portion and the bead portion, and therefore riding comfort may deteriorate. In addition, when rigidities of the sidewall portion and the bead portion are excessively raised by the reinforcing cord, a contact length in a tire circumferential direction may decrease by reduction of a flexibility amount of the pneumatic tire. When the contact length decreases, a ground contact pressure increases. In this case, a shock absorbing property may deteriorate, and therefore riding comfort may deteriorate.

An object to be achieved by the present invention is to improve both steering stability and riding comfort of a pneumatic tire.

### SOLUTION TO PROBLEM

A pneumatic tire according to the present invention includes:

a tread portion that including a tread surface;

a pair of sidewall portions that extend inward in a tire radial direction from both sides of the tread portion in a tire width direction; and

a pair of bead portions each of which includes a bead core that is elongated continuously to an inside of the sidewall portion in the tire radial direction and extends continuously in an annular shape in a tire circumferential direction, and a bead filler disposed adjacent to the bead core and outside the bead core in the tire radial direction.

wherein reinforcing cords are disposed in the bead portion and the sidewall portion such that a density of the reinforcing cords. changes in a range from 20% inclusive to 60% inclusive of a tire sectional height from a tire inner end in the tire radial direction, and such that an outside of an area, which the density changes, has a low density of the reinforcing cords.

According to this configuration, the reinforcing cords are disposed at a low density in an outer portion of the pneumatic tire in the tire radial direction (hereinafter also referred to as outer diameter portion), and disposed at a high density in an inner portion (hereinafter also referred to as inner diameter portion).

A density herein refers to the number of reinforcing cords per unit angle in a tire circumferential direction. The area this density change lies in the range from 20 to 50% of the tire sectional height as described above. Accordingly, a low rigidity region not including the reinforcing cords, a medium rigidity region which includes the reinforcing cords provided at a low density, and a high rigidity region which includes the reinforcing cords provided at a high density are disposed in this order in the tire radial direction from the outside of the pneumatic tire. In this manner, a stepwise rigidity change in the tire radial direction is achieved. If the reinforcing cords are uniformly disposed in the tire radial direction, the low rigidity region not including the reinforcing cords, and the high rigidity region including the reinforcing cords are formed. In this case, rigidity considerably changes at the boundary between the low rigidity region and the high rigidity region. When a portion whose rigidity changes locally and considerably is present, this portion may be bent by a high-G load applied to the pneumatic tire. However, in the configuration which produces a stepwise rigidity change as described above, a considerable change of local rigidity is prevented. Accordingly, a local bend is not easily caused even when a high-G load is applied to the pneumatic tire. Reduction of a bent portion in this manner can improve riding comfort. In addition, excessive increase in rigidity can be reduced more than in a configuration where the reinforcing cords are uniformly disposed in the tire radial direction. In this case, the contact length in the tire circumferential direction is prevented from becoming excessively small. Accordingly, even when a high-G load is applied in the tire width direction at the time of turning, at least a certain contact length is secured. In this case, excessive increase in a ground contact pressure is prevented, that is, impact disperses, and therefore sufficient riding comfort is achievable. Furthermore, in the state that at least a certain contact length is secured, sufficient cornering power is provided, and therefore steering stability improves. In addition, the high rigidity region is provided at the inner diameter portion so that at least a certain level of rigidity of the pneumatic tire can be secured as compared with a case where the reinforcing cords are not provided or a case where the reinforcing cords are uniformly provided at a low density. Accordingly, steering stability can improve.

The reinforcing cords may include a first cord, and a second cord that has a smaller length in the tire radial direction than a length of the first cord. The first cord and the second cord may be alternately disposed in the tire circumferential direction.

According to this configuration, the density change is easily achieved by at least two cords having different lengths so that the pneumatic tire can be manufactured by a simple method. In addition, the first cord and the second cord are alternately disposed in the tire circumferential direction. In this case, uneven rigidity distribution is also avoidable in the tire circumferential direction. Accordingly, riding comfort can further improve.

The pneumatic tire may further includes at least one carcass ply folded outward from an inside in the tire width direction, and disposed around the bead core and the bead filler. An arrangement may be made in an order of a folded end of the carcass ply, an outer end of the first cord, an outer end of the bead filler, and an outer end of the second cord from an outside to an inside in the tire radial direction.

According to this configuration, the arrangement including the carcass ply and the bead filler is specified in addition to the density change of the reinforcing cords. In this case, steps of the rigidity change in the tire radial direction further increase. Accordingly, riding comfort can further improve.

The pneumatic tire may further include a belt that extends in the tire width direction inside the tread Portion. A height of the folded end of the carcass ply in the tire radial direction may be 1.05 times or more than a height of the outer end of the first cord in the tire radial direction. The folded end of the carcass ply and the belt are allowed to partially overlap with each other. An overlapping amount in case of overlap between the folded end of the carcass ply and the belt may be 20 mm or less.

According to this configuration, the folded end of the carcass ply and the outer ends of the reinforcing cords do not overlap with each other under the specification of 1.05 times or more as described above. Accordingly, the stepwise rigidity change is further securely achievable. Moreover, the length of the carcass ply is limited to a certain value or smaller. Accordingly, the length of the carcass ply becomes smaller and therefore the weight and cost can decrease.

An outermost end of the reinforcing cord may be disposed in a range from 30% inclusive to 70% inclusive of the tire sectional height from the tire inner end in the tire radial direction.

According to this configuration, the reinforcing cords can be disposed at appropriate positions for which improvement in rigidity is required. A range smaller than 30%, which is out of the range of the reinforcing cords described above, is a range originally having a high rigidity achieved by the bead core, the bead filler and the like. Accordingly, even when the reinforcing cords are disposed only in this range, necessary rigidity cannot be acquired in the outer diameter portion. When the reinforcing cords are disposed in a range larger than 70% described above, rigidity at the outer diameter portion excessively increases. In this case, riding comfort may deteriorate. Accordingly, when the reinforcing cords are disposed within an appropriate range from 30% inclusive to 70% inclusive as described above, appropriate rigidity can be acquired.

An inclination angle of each of the reinforcing cords with respect to the tire circumferential direction may lie in a range from 15 degrees inclusive to 45 degrees inclusive.

According to this configuration, appropriate rigidity can be secured by specifying the inclination angle of the reinforcing cords. The reinforcing cords are deformed more greatly when a force is applied in the bending direction than in the expansion/contraction direction (longitudinal direction). In this case, rigidity at the portion including the reinforcing cords can be raised more greatly in the longitudinal direction than in the bending direction. The longitudinal direction of the reinforcing cords comes closer to the tire radial direction as the inclination angle increases. In this case, rigidity in the tire radial direction can be raised, but rigidity in the tire circumferential direction decreases. On the contrary, the longitudinal direction of the reinforcing cord comes closer to the tire circumferential direction as the inclination angle decreases. In this case, rigidity in the tire circumferential direction can be raised, but rigidity in the tire radial direction decreases. When the inclination angle lies in a range from 15 degrees inclusive to 45 degrees inclusive, rigidity becomes appropriate in each of the tire radial direction and the tire circumferential direction. Accordingly, appropriate steering stability and riding comfort can be securely achieved.

According to the present invention, both steering stability and riding comfort are achievable by disposing reinforcing cords of a pneumatic tire such that an outside in a tire radial direction has a low density.

### BRIEF DESCRIPTION OF THE DRAWINGS

The foregoing and the other features of the present, invention will become apparent from the following description and drawings of an illustrative embodiment of the invention in which:

FIG. 1 is a perspective partial view including a cross section of a pneumatic tire in a tire meridian direction according to an embodiment of the present invention;

FIG. 2 is an enlarged partial view of the cross section of FIG. 1;

FIG. 3 is a schematic side view of the pneumatic tire showing an arrangement of reinforcing cords;

FIG. 4 is an enlarged partial view of FIG. 3;

FIG. 5 is a schematic partial side view of a pneumatic tire according to Comparative Example 1;

FIG. 6 schematic partial side view pneumatic tire according to Comparative Example 2;

FIG. 7 is a schematic partial side view of pneumatic tire according to Example 2;

FIG. 8 is a schematic partial side view of pneumatic tire according td another example;

FIG. 9 is a cross-sectional view in a tire meridian direction, showing a first modified example of the pneumatic tire;

FIG. 10 is a cross-sectional view in a tire meridian direction, showing a second modified example of the pneumatic tire; and

FIG. 11 is a cross-sectional view in a tire meridian direction, showing a third modified example of the pneumatic tire.

### DETAILED DESCRIPTION OF EMBODIMENTS

Embodiments of the present invention will be hereinafter described with reference to the accompanying drawings.

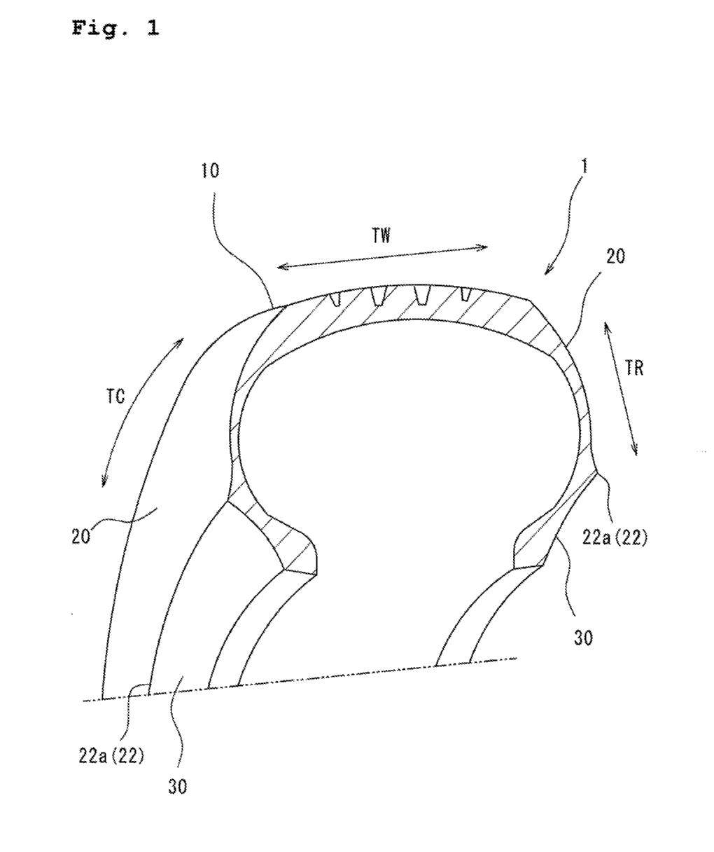

FIG. 1 is a perspective partial view including a cross section of a pneumatic tire 1 (hereinafter also abbreviated as tire 1) in a tire meridian direction according to the present embodiment. The tire 1 is attached to a rim (not shown) to form an air layer between the tire 1 and the rim. The tire 1 includes a tread portion 10 constituting a tread surface, a pair of sidewall portions 20 extending inward in a tire radial direction TR from both sides of the tread portion 10 in a tire width direction TW, and a pair of bead portions 30 continuous to an inside of the sidewall portions 20 in the tire radial direction TR and assembled to the rim.

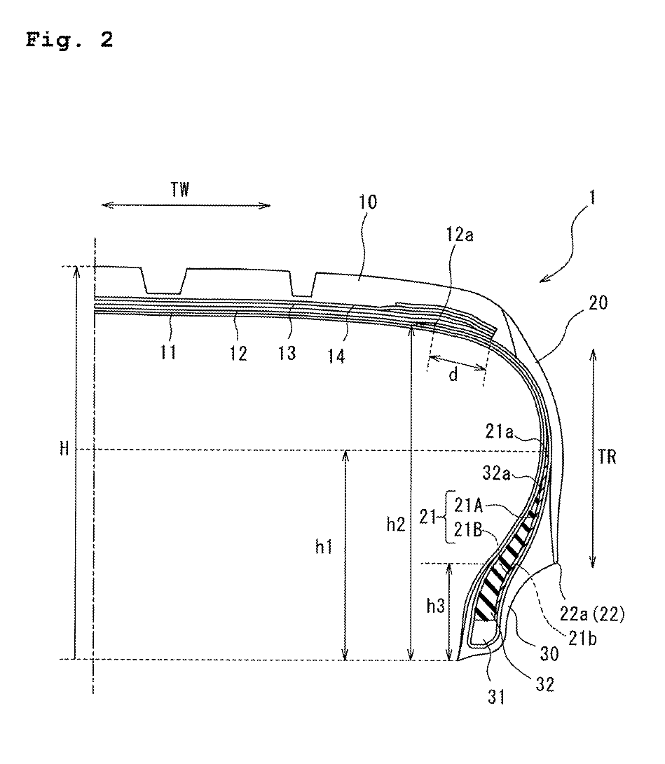

FIG. 2 is an enlarged partial view of the cross section of FIG. 1.

A carcass ply 12, a belt 13, and a tread reinforcing layer 14 are embedded in the tread portion 10 in a direction toward the outside from an inner liner 11 located inside in the tire radial direction TR. Both end portions of the carcass ply 12 in the tire width direction TW extend toward the sidewall portions 20 and the bead portions 30.

The carcass ply 12 and reinforcing cords 21 made of steel are embedded in each of the sidewall portions 20. The reinforcing cords 21 include first cords 21A, and second cords 21B each having a smaller length in the tire radial direction TR than lengths of the first cords 21A. The first cords 21A and the second cords 21B are hereinafter also referred to as the reinforcing cords 21 without distinction between the respective cords 21A and 21B. The carcass ply 12 and the reinforcing cords 21 in the sidewall portion 20 extend substantially in the tire radial direction TR. The sidewall portion 20 further includes a rim protector 22 which has a top portion 22a protruding outward in the tire width direction TW, and continuously extends in an annular shape in a tire circumferential direction TC. The rim protector 22 has a function of protecting the rim (not shown) from external damage.

A bead core 31 and a bead filler 32 each continuously extending in an annular shape in the tire circumferential direction TC are embedded in each of the bead portions 30. The bead core 31 and the bead filler 32 are high rigidity portions for assembling the bead portion 30 to the rim (not shown). In addition, the carcass ply 12 is disposed inside the bead portion 30 in such a condition as to fold a region around the bead core 31 and the bead filler 32 in a direction from the inside toward the outside. An end portion 12a of the folded carcass ply 12 extends beyond the bead portion 30 and the sidewall portion 20 to the tread portion 10, and overlaps with the belt 13. Specifically, an overlapping amount d between the folded carcass ply 12 and the belt 13 is 12 mm. The overlapping amount d is preferably in a range from 5 mm inclusive to 20 mm inclusive.

The reinforcing cords 21 are disposed in the bead portion 30 between the folded carcass ply 12 and the bead filler 32. One end (lower end in figure) of the first cord 21A is connected to the bead core 31, while an opposite end (upper end in figure) 21a extends to the sidewall portion 20. One end (lower end in figure) of the second cord 21B is connected to the bead core 31, while an opposite end (upper end in figure) 21b terminates within the bead portion 30. The first cord 21A and the second cord 21B constitute a side reinforcing layer with rubber coating. More specifically, the opposite end (outer end in tire radial direction TR) 21a of the first cord 21A is disposed at a height hi of about 55% of a tire sectional height H (h1=0.55H). The opposite end (outer end in tire radial direction TR) 21a of the reinforcing cord 21 is preferably disposed in a range from 30% inclusive to 70% inclusive of the tire sectional height H (0.3H≤h1≤0.7H).

As for a positional relationship between the respective parts, a folded end 12a of the carcass ply 12, an outer end 21a of the first cord 21A, an outer end 32a of the bead filler 32, and an outer end 21b of the second cord 21B are disposed this order from the outside to the inside in the tire radial direction TR. Particular this positional relationship, a height h2 of the folded end 12a of the carcass ply 12 in the tire radial direction TR is preferably 1.05 times or more than the height h1 of the outer end 21a of each of the reinforcing cords 21 in the tire radial direction TR (h2≥1.05h1). According to the present embodiment, the height h2 is about 1.5 times larger than the height h1 (h2=1.5h1).

As for a positional relationship between the respective parts in the tire width direction TW, the carcass ply 12 (after folding), the reinforcing cords 21, the bead filler 32, and the carcass ply 12 (before folding) are disposed in this order from the outside to the inside. However, the respective parts are not required to be disposed in this manner. For example, the reinforcing cords 21 may be arranged in following four ways, (1) side the carcass ply 12 (before folding), (2) between the carcass ply 12 (before folding) and the bead filler 32, (3) between the bead filler 32 and the carcass ply 12 (after folding) as shown in FIG. 2, and (4) outside the carcass ply 12 (after folding).

In the present embodiment, the tread portion 10, the sidewall portion 20, and the bead portion 30 are made of different rubber materials. Accordingly, lines dividing the respective portions 10, 20, and 30 in FIG. 2 indicate boundaries between different materials each constituting the corresponding portion 10, 20, or 30, and therefore the respective portions 10, 20, and 30 are sectioned by the corresponding lines.

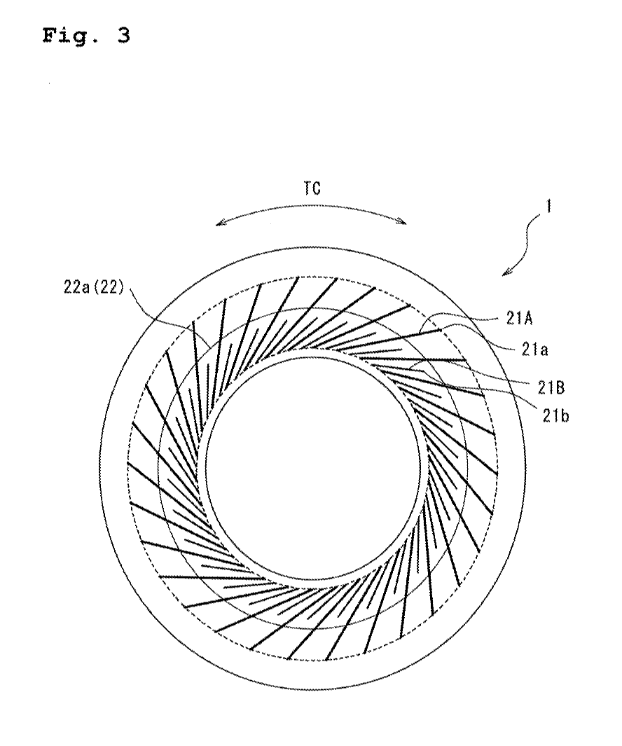

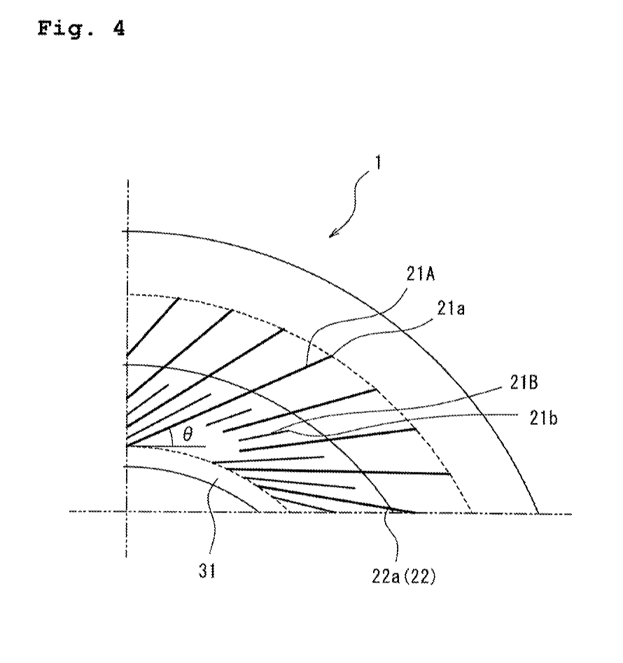

FIG. 3 is a schematic side view of the tire 1 showing an arrangement of the reinforcing cords 21. FIG. 4 is an enlarged partial view of FIG. 3. FIG. 4 does not show a part of the reinforcing cords 21 for convenience of explanation.

Each of the reinforcing cords 21 is linear from viewed in the tire width direction TW, and the plurality of individual reinforcing cords 21 are spaced apart from each other in the tire circumferential direction TC. The reinforcing cords 21 are disposed in the bead portion 30 and the sidewall portion 20 such that density changes at a height h3 corresponding to 40% of the tire sectional height H, for example, from a tire inner end in the tire radial direction TR, and that the outside of an area, in which the density changes, has a low density. A density herein refers to the number of reinforcing cords per unit angle in a tire circumferential direction. Specifically, the outer end 21b (indicated by broken line) of the second cord 21B in the tire radial direction TR is located at the height h3 corresponding to 25% of the tire sectional height H, for example, from the tire inner end. The area of the density change preferably lies in a range from 20% inclusive to 60% inclusive. In addition, the first cord 21A and the second cord 21B are alternately disposed in the tire circumferential direction TC.

According to the present embodiment, each of the first cord 21A and the second cord 21B is disposed at an inclination angle θ of 23 degrees with respect to the tire circumferential direction TC. The inclination angle with respect to the tire circumferential direction TC refers to the inclination angle θ of the first cord 21A and the second cord 21B with respect to the tire circumferential direction TC at the inner end in the tire radial direction TR. The inclination angle θ preferably lies in a range from 15 degrees inclusive to 45 degrees inclusive.

According to the configuration of the present embodiment, following advantages are produced.

(1) In the present embodiment, the reinforcing cords 21 are disposed so as, to have a low density in the outer diameter portion, and so as to have a high density in the inner diameter portion in the tire radial direction TR of the tire 1. The area of this density change (height h3) lies in the range from 20% to 50% of the tire sectional height H (25% in the present embodiment) as described above. Accordingly, a low rigidity region not including the reinforcing cords, a medium rigidity region including the reinforcing cords 21 provided at a low density, and a high rigidity region including the reinforcing cords 21 provided at a high density are disposed in this order in the tire radial direction TR from the outside of the tire 1. In this manner, the stepwise rigidity chance in the tire radial direction TR is achieved. If the reinforcing cords 21 are uniformly disposed the tire radial direction TR, the low rigidity region not including the reinforcing cords 21, and the high rigidity region including the reinforcing cords 21 are formed. In this case, rigidity considerably changes at the boundary between the low rigidity region and the high rigidity region. When a portion whose rigidity changes locally and considerably is present, this portion may be bent by a high-G load applied to the tire. However, in the configuration which produces a stepwise rigidity change as described above, considerable change of local rigidity is prevented. Accordingly, a local bend is not easily caused even when a high-G load is applied to the tire 1. Reduction of a bent portion in this manner can improve riding comfort. In addition, excessive increase in rigidity can be reduced more than in a configuration where the reinforcing cords 21 are uniformly disposed in the tire radial direction TR. In this case, the contact length in the tire circumferential direction TC is prevented from becoming excessively small. Accordingly, even when a high-G load is applied in the tire width direction TW at the time of turning, at least a certain contact length is secured. In this case, excessive increase in a ground contact pressure is prevented, that is, impact disperses, and therefore sufficient riding comfort is achievable. Furthermore, in the state that at least a certain contact length is secured, sufficient cornering power is provided, and therefore steering stability improves. In addition, the high rigidity region is provided at the inner diameter portion so that at least a certain level of rigidity of the tire 1 can be secured as compared with a case where the reinforcing cords 21 are not provided or a case where the reinforcing cords 21 are uniformly provided at a low density. Accordingly, steering stability can improve.

(2) The density change is easily achieved by the first cord 21A and the second cord 21B having different lengths so that the tire 1 can be produced by a simple method. In addition, the first cord 21A and the second cord 21B are alternately disposed in the tire circumferential direction TC. In this case, uneven rigidity distribution is also avoidable in the tire circumferential direction TC. Accordingly, riding comfort can further improve.

(3) The arrangement including the carcass ply 12 and the bead filler 32 is specified as well as the density change of the reinforcing cords 21. Rigidity therefore changes further stepwise in the tire radial direction TR. Accordingly, riding comfort can further improve.

(4) The folded end 12a of the carcass ply 12 and the outer end 21a of the first cord 21A do not overlap with each other under the specification of 1.05 times or more than as described above. Accordingly, the stepwise rigidity change is further securely achievable. Moreover, the overlapping amount d between the carcass ply 12 and the belt 13 is limited to a certain value or smaller. Accordingly, the length of the carcass ply 12 becomes smaller, and therefore the weight and cost can decrease.

(5) The height h1 is set within a range from 30% inclusive to 70% inclusive (55% in the present embodiment) of the tire sectional height H. Accordingly, the first cord 21A can be disposed at an appropriate position for which rigidity improvement is demanded. A range smaller than 30% of the tire sectional height H, which is out of the range of the first cord 21A, is a range originally having a high rigidity achieved by the bead core 31, the bead filler 32 and the like. Accordingly, even when the first cord 21A is disposed only in this range, necessary rigidity cannot be acquired in the outer diameter portion. When the first cord 21A is disposed in a range larger than 70% described above, rigidity at the outer diameter portion excessively increases. In this case, riding comfort may deteriorate. Accordingly, when the reinforcing cords are disposed within an appropriate range from 30% inclusive to 70% inclusive as described above, appropriate rigidity can be acquired.

(6) The inclination angle θ of each of the reinforcing cords 21 is set to 23 degrees. Accordingly, appropriate rigidity can be secured. The reinforcing cords 21 are deformed more greatly when a force is applied in the bending direction than in the expansion/contraction direction (longitudinal direction). In this case, rigidity at the portion including the reinforcing cords 21 can be raised more greatly in the longitudinal direction than in the bending direction. The longitudinal direction of the reinforcing cords 21 comes closer to the tire radial direction TR as the inclination angle θ increases. In this case, rigidity in the tire radial direction TR can be raised, but rigidity in the tire circumferential direction TC decreases. On the contrary, the longitudinal direction of the reinforcing cord 21 comes closer to the tire circumferential direction TC as the inclination angle θ decreases. In this case, rigidity in the tire circumferential direction TC can be raised, but rigidity in the tire radial direction TR decreases. When the inclination angle θ lies in a range from 15 degrees inclusive to 45 degrees inclusive, rigidity becomes appropriate in each of the tire radial direction TR and the tire circumferential direction TC. Accordingly, appropriate steering stability and riding comfort can be securely achieved.

### Example

As shown in following Table 1, steering stability and riding comfort of tires according to Comparative Examples and Examples were evaluated based on indexes on the assumption that respective indexes of Comparative Example 1 are set to 100.

As for steering stability, a test run of a car provided with the tire was carried out at a specified vehicle air pressure, on a dry road surface, with acceleration, brake, turn, and lane change. A specialized driver made sensory evaluation for relative steering stability from viewpoints of marginal performance, response performance, and straight running performance.

As for riding comfort, a test run similar to the above test run for steering stability was carried out. A specialized driver made sensory evaluation for relative riding comfort from viewpoints of shock, vibration, and the like.

The respective indexes of steering stability and riding comfort become preferable as values of the indexes increase.

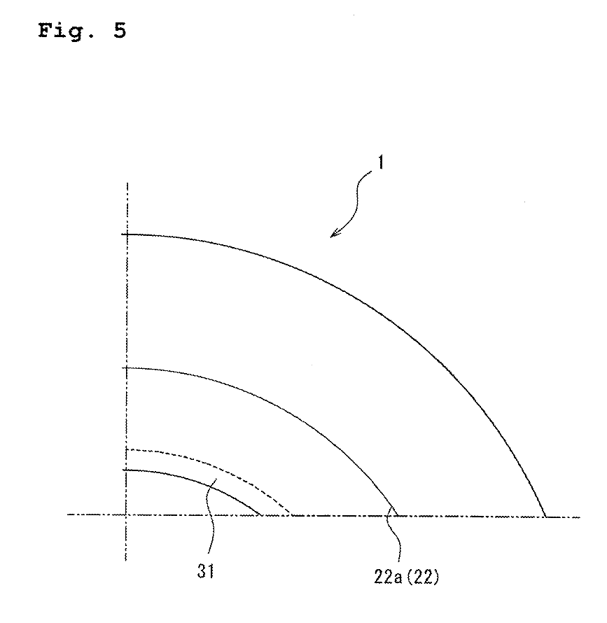

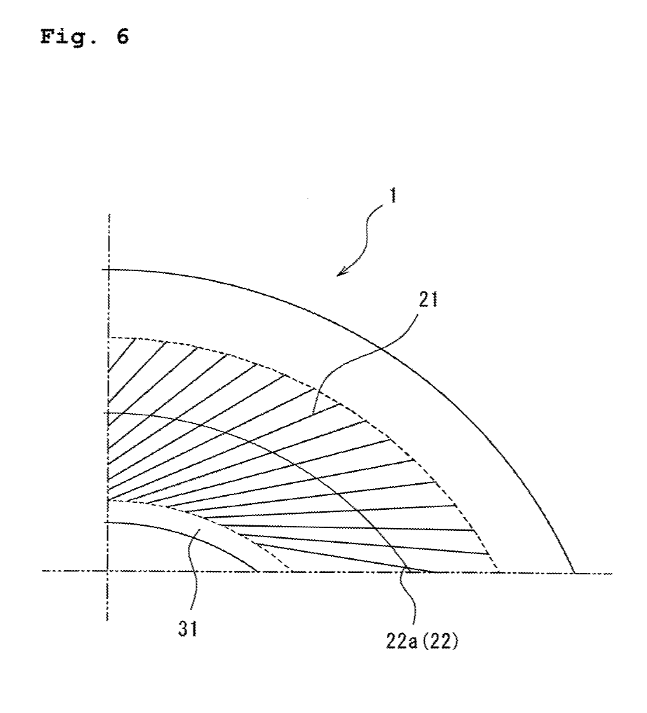

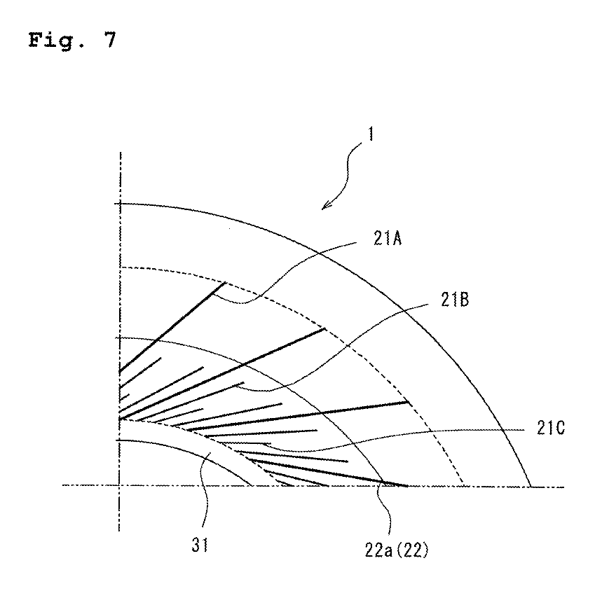

According to a shape of Comparative Example 1 shown in FIG. 5, the reinforcing cords 21 are not provided. According to a shape of Comparative Example 2 shown in FIG. 6, the reinforcing cords 21 are disposed so as to have an inclination angle of 23 degrees. One type of cords is provided as the reinforcing cords 21. According to Example 1 shown in FIG. 4, two types of cords (first cord 21A and second cord 21B) are alternately disposed to constitute the reinforcing cords 21, and are each disposed to have an inclination angle of 23 degrees. In Example 2 shown in FIG. 7, three types of cords (first cord 21A, second cord 215, and third cord 21C) are disposed to constitute the reinforcing cords 21, and are all disposed at an inclination angle of 23 degrees. In the present example, the first cord 21A is the longest, the second cord is the second longest, and the third cord 21C is the shortest. Particularly, the three types of cords 21A to 21C are disposed in the order of the first cord 21A, the second cord 21B, the third cord 21C, the second cord 21S, and the first cord 21A in the tire circumferential direction TC. This arrangement is repeated. This arrangement can prevent uneven rigidity distribution in the tire circumferential direction TC.

TABLE 1

| | Comparative | Comparative | | |
|---|---|---|---|---|
| | Example 1 | Example 2 | Example 1 | Example 2 |
| Shape | No cord | Cords of | Cords of | Cords of |
| etc. | | one type at | two types | three types |
| | | inclination | at | at |
| | | angle of 23 | inclination | inclination |
| | | degrees | angle of 23 | angle of 23 |
| | | | degrees | degrees |
| Riding | 100 | 90 | 96 | 95 |
| comfort | | | | |
| Steering | 100 | 105 | 108 | 106 |
| stability | | | | |

In Comparative Example 2, rigidity of the tire was more raised by the reinforcing cords 21 than in Comparative Example 1, and therefore preferable results of steering stability were obtained. However, riding comfort was deteriorated. In each of Examples 1 and 2, more preferable results of riding comfort and steering stability than in Comparative Example 2 were obtained by providing the plurality of types of reinforcing cords 21. Compared with Comparative Examples 1. Preferable results were partially obtained. Based on these results, it is recognizable that increase in steering stability and reduction of deterioration of riding comfort are both achieved by providing the plurality of types of reinforcing cords 21.

Although the specific embodiments of the present invention have been described, the present invention is not limited to the above embodiments. Various modifications may be made without departing from the scope of the present invention.

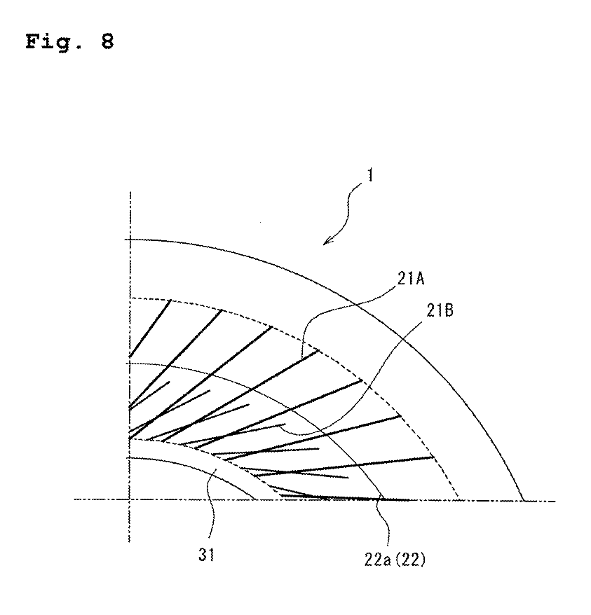

For example, the inclination angles of the first cords 21A and the second cords 21B may differ from each other, or more specifically, the first cords 21A and the second cords 21B may cross each other as shown in FIG. 8. Each inclination angle of the first cords 21A is preferably larger than each inclination angle of the second cords 21B. In this case, rigidity at the outer diameter portion in the tire circumferential direction TC does not excessively increase. Accordingly, the contact length in the tire circumferential direction TC does not become excessively small.

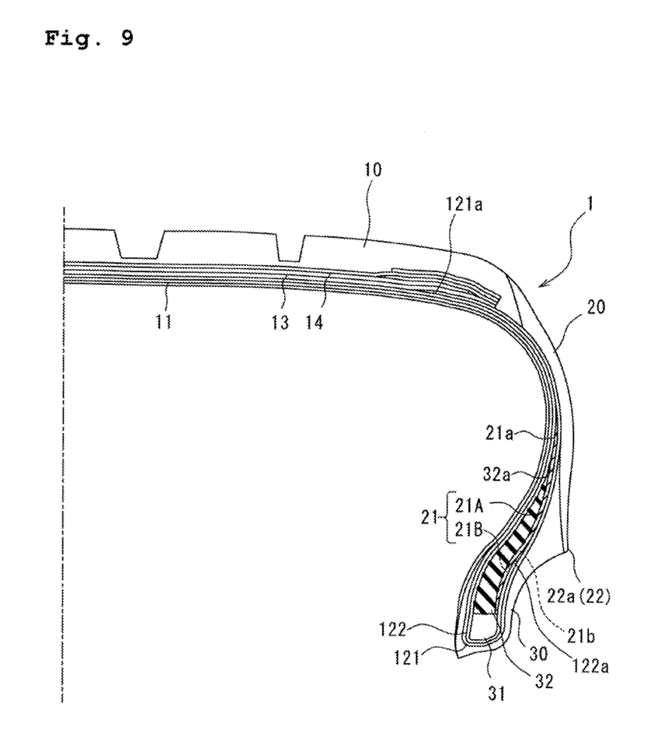

For example, two carcass plies 121, 122 may be provided as shown in FIG. 9. That is, the first ply 121 and the second ply 122 may be disposed. In this case, the respective parts have such a positional relationship that a folded end 121a of the first ply 121, the outer end 21a of the first cord 21A, the outer end 32a of the bead filler 32, the outer end 21b of the second cord 21B, and a folded end 122a of the second ply 122 are disposed in this order from the outside to the inside in the tire radial direction TR. Even when two carcass plies 121, 122 are disposed in this manner, the reinforcing cords 21 are allowed to be located at any positions in the tire width direction TW similarly to the first embodiment.

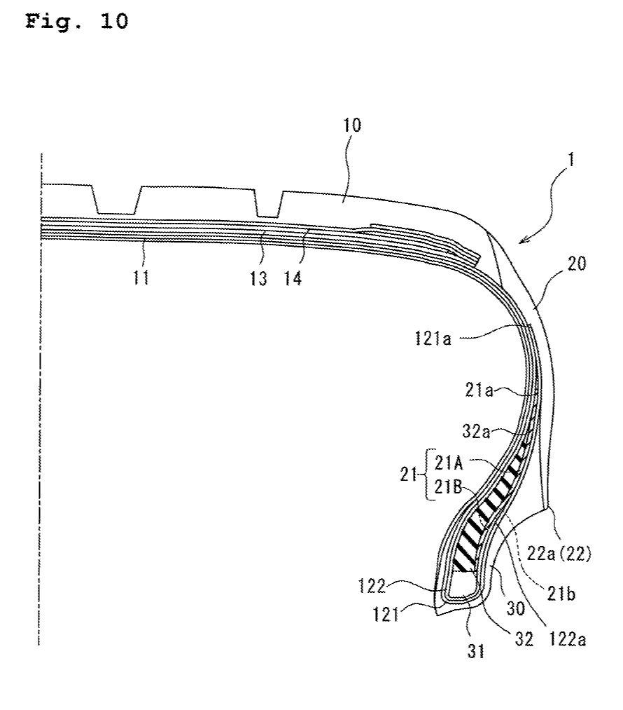

As shown in FIG. 10, the folded carcass plies 121 and 122 and the belt 13 are not necessarily required to overlap with each other. In the example of FIG. 9, the first ply 121 partially overlaps with the belt 13. However, this overlap is not necessarily required. According to a modification of FIG. 10, the folded end 121a of the first ply 121 is positioned within the sidewall portion 20, while the folded end 122a of the second ply 122 is positioned within the bead portion 30.

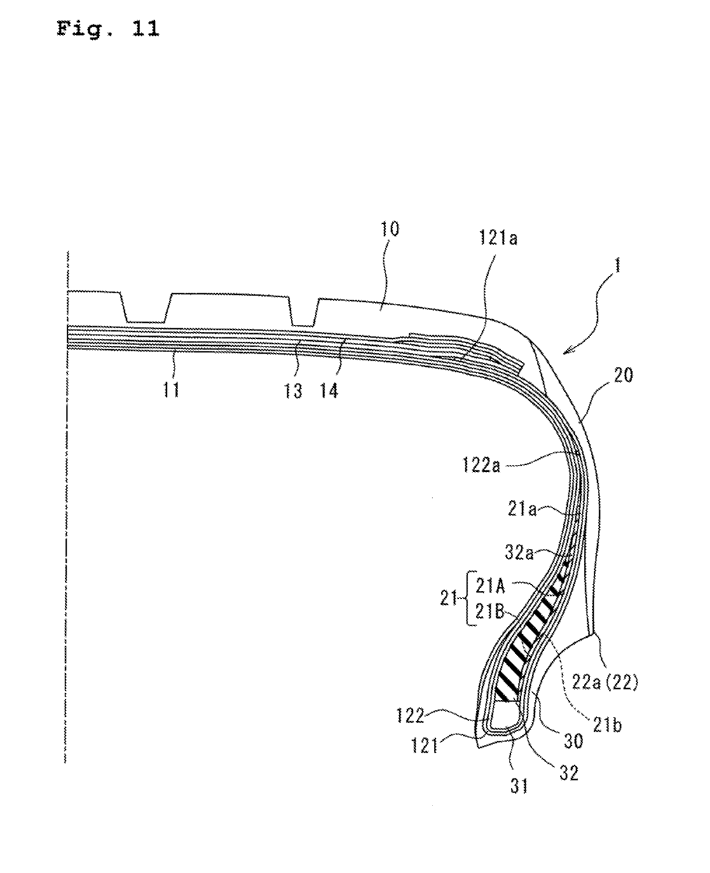

The positional relationship between the respective parts in the tire radial direction TR may be determined in a different manner. For example, as shown in FIG. 11, the respective parts may have such a positional relationship that the folded end 121a of the first ply 121, the folded end 122a of the second ply 122, the outer end 21a of the first cord 21A, the outer end 32a of the bead filler and the outer end 21b of the second cord 21B are disposed in this order from the outside to the inside in the tire radial direction TR. It is particularly preferable that the parts having larger lengths in the tire radial direction TR are disposed at positions closer to the outside in the tire width direction TW.

What is claimed is:

1. A pneumatic tire comprising:
a tread portion that including a tread surface;
a pair of sidewall portions that extend inward in a tire radial direction from both sides of the tread portion in a tire width direction; and
a pair of bead portions each of which includes a bead core that is elongated continuously to an inside of the sidewall portion in the tire radial direction and extends continuously in an annular shape in a tire circumferential direction, and a bead filler disposed adjacent to the bead core and outside the bead core in the tire radial direction,
wherein reinforcing cords are disposed in the bead portion and the sidewall portion such that a density of the reinforcing cords changes in a range from 20% inclusive to 60% inclusive of a tire sectional height from a tire inner end in the tire radial direction, and such that an outside of an area, in which the density change changes, has a low density of the reinforcing cords.

2. The pneumatic tire according to claim 1, wherein
the reinforcing cords include a first cord, and a second cord that has a smaller length in the tire radial direction than a length of the first cord, and
the first cord and the second cord are alternately disposed in the tire circumferential direction.

3. The pneumatic tire according to claim 2, further comprising
at least one carcass ply folded outward from an inside in the tire width direction, and disposed around the bead core and the bead filler,
wherein an arrangement is made in an order of a folded end of the carcass ply, an outer end of the first cord, an outer end of the bead filler, and an outer end of the second cord from an outside to an inside in the tire radial direction.

4. The pneumatic tire according to claim 3, further comprising
a belt that extends in the tire width direction inside the tread portion, wherein
a height of the folded end of the carcass ply in the tire radial direction is 1.05 times or more than a height of the outer end of the first cord in the tire radial direction, and
the folded end of the carcass ply and the belt are allowed to partially overlap with each other, and an overlapping amount in case of overlap between the folded end of the carcass ply and the belt is 20 mm or less.

5. The pneumatic tire according to claim 1, wherein an outermost end of the reinforcing cord is disposed in a range from 30% inclusive to 70% inclusive of the tire sectional height from the tire inner end in the tire radial direction.

6. The pneumatic tire according to claim 1, wherein an inclination angle of each of the reinforcing cords with respect to the tire circumferential direction lies in a range from 15 degrees inclusive to 45 degrees inclusive.

7. The pneumatic tire according to claim 2, wherein an outermost end of the reinforcing cord is disposed in a range from 30% inclusive to 70% inclusive of the tire sectional height from the tire inner end in the tire radial direction.

8. The pneumatic tire according to claim 3, wherein an outermost end of the reinforcing cord is disposed in a range from 30% inclusive to 70% inclusive of the tire sectional height from the tire inner end in the tire radial direction.

9. The pneumatic tire according to claim 4, wherein an outermost end of the reinforcing cord is disposed in a range from 30% inclusive to 70% inclusive of the tire sectional height from the tire inner end in the tire radial direction.

10. The pneumatic tire according to claim 2, wherein an inclination angle of each of the reinforcing cords with respect to the tire circumferential direction lies in a range from 15 degrees inclusive to 45 degrees inclusive.

11. The pneumatic tire according to claim 3, wherein an inclination angle of each of the reinforcing cords with respect to the tire circumferential direction lies in a range from 15 degrees inclusive to 45 degrees inclusive.

12. The pneumatic tire according to claim 4, wherein an inclination angle of each of the reinforcing cords with respect to the tire circumferential direction lies in a range from 15 degrees inclusive to 45 degrees inclusive.

13. The pneumatic tire according to claim 5, wherein an inclination angle of each of the reinforcing cords with respect to the tire circumferential direction lies in a range from 15 degrees inclusive to 45 degrees inclusive.

14. The pneumatic tire according to claim 7, wherein an inclination angle of each of the reinforcing cords with respect to the tire circumferential direction lies in a range from 15 degrees inclusive to 45 degrees inclusive.

15. The pneumatic tire according to claim 8, wherein an inclination angle of each of the reinforcing cords with respect to the tire circumferential direction lies in a range from 15 degrees inclusive to 45 degrees inclusive.

16. The pneumatic tire according to claim 9, wherein an inclination angle of each of the reinforcing cords with respect to the tire circumferential direction lies in a range from 15 degrees inclusive to 45 degrees inclusive.
